(19) United States
(12) Patent Application Publication
(10) Pub. No.: US 2015/0198234 A1
(43) Pub. Date: Jul. 16, 2015

(54) Deaerator Apparatus

(71) Applicant: Caterpillar Inc., Peoria, IL (US)

(72) Inventors: Jaspen Patenaude, Peoria, IL (US); Mark Batdorff, Washington, IL (US); Jay Steffen, Metamora, IL (US); Tyler R. Scarlata, Washington, IL (US)

(73) Assignee: Caterpillar Inc., Peoria, IL (US)

(21) Appl. No.: 14/155,029

(22) Filed: Jan. 14, 2014

(51) Int. Cl. F16H 57/04; B01D 19/00

(52) U.S. Cl. CPC F16H 57/0458; B01D 19/0052

(57) ABSTRACT

A seal carrier that is used to transmit hydraulic fluid to control pistons in a transmission includes a center passage and connecting passages to one or more oil passages. As the seal carrier rotates during operation, the seal carrier acts as a centrifuge and entrapped air in the hydraulic fluid is separated from the hydraulic fluid. The released air moves into the center passage and out through one of the connecting passages, ultimately to a tank or reservoir. A poppet valve in the hydraulic fluid drain rail maintains a positive pressure on the hydraulic fluid at all times to create a pressure differential between the central passage and the tank.

### TECHNICAL FIELD

The present disclosure relates to hydraulic implements and more particularly to a seal carrier that removes air from a hydraulic fluid in a transmission.

### BACKGROUND

A transmission or power takeoff (PTO) is a machine that uses one or more of a torque converter, pumps, planetary gear sets, clutches, and valves to convert power from a source, such as a gas or diesel engine into power usable at an output, such as tires, tracks, or pumps, among others. Hydraulic fluid is driven by the pump and channeled by the valves to operate clutches and actuate gear levers.

The effectiveness of the transmission or similar equipment in terms of mechanical efficiency and smooth, accurate gear changes is a function of the volume of the hydraulic fluid or oil. The oil can vary in volume primarily due to entrapped air and can dramatically affect the shift quality of the transmission. However, due to the complexity of the system and the cramped quarters, a traditional deaerator that tangentially injects oil into a canister with a top-facing hole, such as in EP1166841 is not practical.

### SUMMARY

According to one aspect of the disclosure, a deaerator system may include a seal carrier having a cylindrical outer surface, a central passage located around an axial centerline of the seal carrier and a radial passage having a proximal end at the central passage and a distal end at the cylindrical outer surface. The seal carrier may also include an axial passage carrying hydraulic fluid through the seal carrier. The axial passage may be displaced from the axial centerline of the seal carrier and non-overlapping with the central passage. The seal carrier may further include a second radial passage connecting the axial passage to the central passage, wherein the second radial passage has a smaller diameter than the axial passage.

In another aspect of the disclosure, a method of centrifuging air from an oil supply may include rotating a component having first and second fluid passages, introducing oil to a first passage, the first passage displaced from an axial centerline of the component, and collecting air displaced from the oil in a second passage of the component. The second passage may be coupled to the first passage and may have a smaller cross section than the first passage. The method may also include venting the air in the second passage to a tank.

In yet another aspect of the disclosure, an apparatus that deaerates oil in a transmission, may include a shaft with a first passage that couples fluid to a piston and a second passage that couples the first passage to a vent. The apparatus may also include a backpressure device coupled to the first passage, the backpressure device creating a positive pressure between the first passage and the vent. When the shaft is rotated, air displaced via rotation of the shaft is vented via the second passage.

These and other benefits will become apparent from the specification, the drawings and the claims.

### BRIEF DESCRIPTION OF THE DRAWINGS

FIG. 1 is a perspective view of a transmission;

FIG. 2 is a side view of the transmission of FIG. 1;

FIG. 3 is a simplified and representative diagram showing a seal carrier and related components of a transmission;

FIG. 4 is another simplified and representative diagram showing another embodiment of a seal carrier and related components of a transmission;

FIG. 5 is a cutaway view of a seal carrier configured for oil deaeration;

FIG. 6 is a cutaway view of a poppet valve in a drain rail; and

FIG. 7 is a simplified and representative diagram showing another embodiment of the deaerator apparatus;

FIG. 8 is a simplified and representative diagram showing another embodiment of the deaerator apparatus;

FIG. 9 is a simplified and representative diagram showing another embodiment of the deaerator apparatus;

FIG. 10 is a simplified and representative diagram showing another embodiment of the deaerator apparatus;

FIG. 11a and FIG. 11b is a simplified and representative diagram showing another embodiment of the deaerator apparatus;

FIG. 12a and FIG. 12b is a simplified and representative diagram showing another embodiment of the deaerator apparatus;

FIG. 13 is a flowchart of a method of using a seal carrier for deaerating oil or other hydraulic fluid.

### DESCRIPTION

The following discussion pertains to transmissions, particularly transmissions that use hydraulic fluid to activate clutches or other assemblies that effect the changes in input-to-output shaft speed and torque. In the following discussion, the terms hydraulic fluid and oil may be used interchangeably.

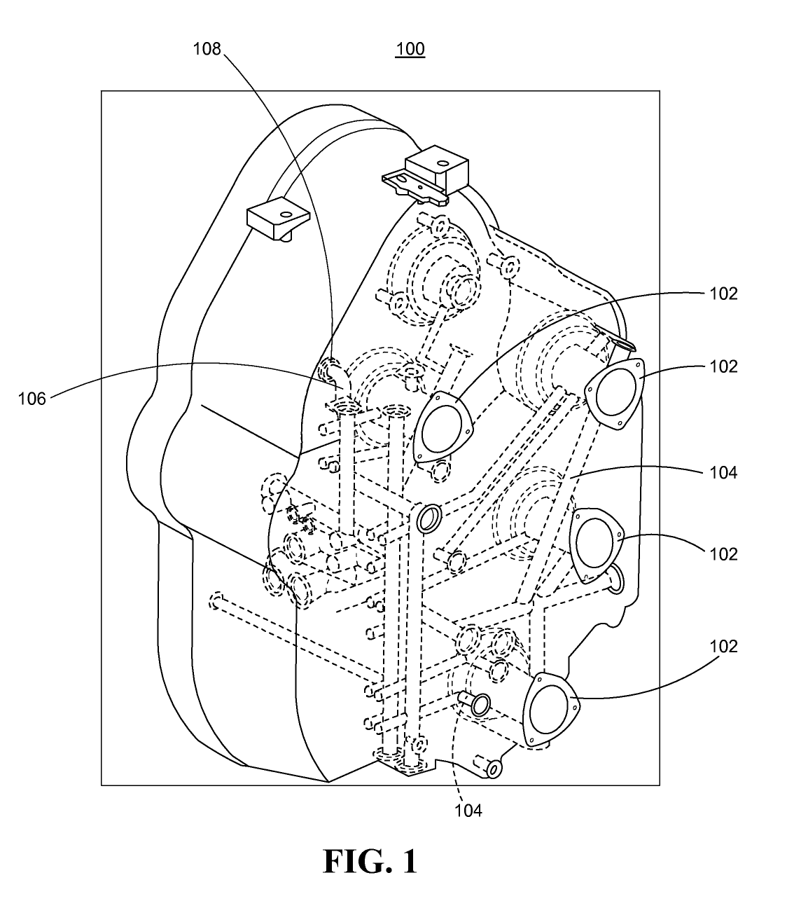

FIG. 1 is a perspective view of a transmission 100. The view of FIG. 1 illustrates a plurality of shaft casings 102 into which shafts and seal carriers are disposed. FIG. 1 also illustrates oil passages 104 that are coupled to the shaft casings 102. A poppet valve 108, shown in more detail below, may be mounted at a top (with respect to gravity) of a drain rail 106, that carries low pressure oil.

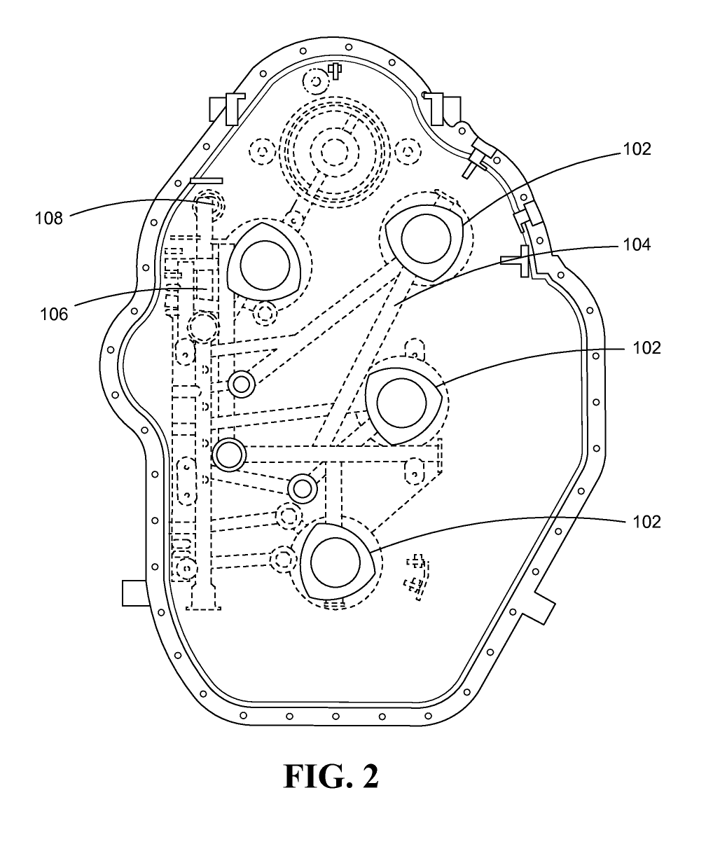

FIG. 2 is a side view of the transmission 100 of FIG. 1 showing the shaft casings 102, oil passages 104, drain rail 106, and poppet valve 108.

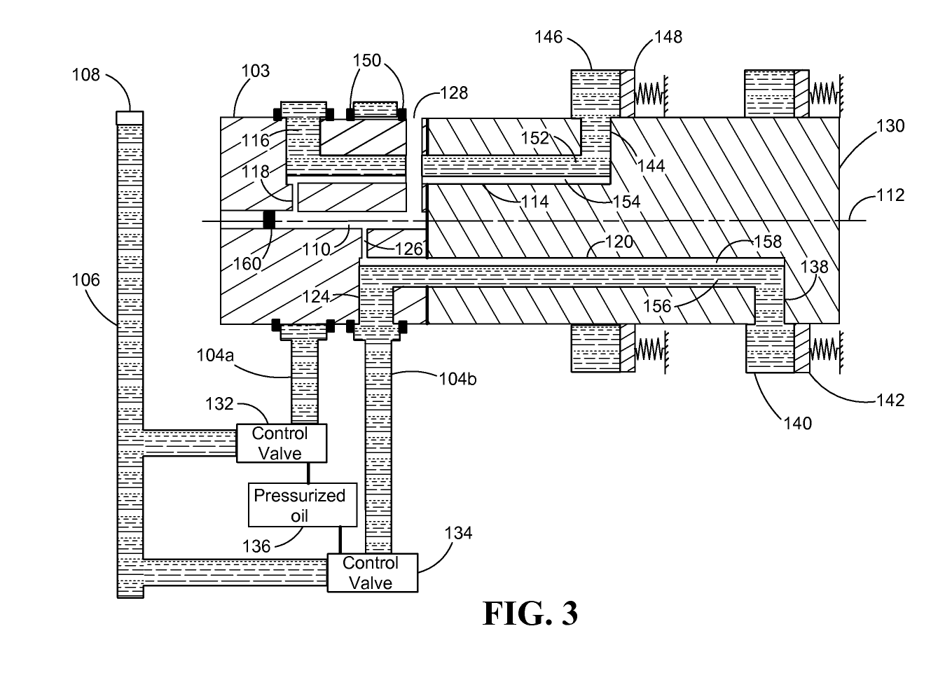

FIG. 3 is a simplified and representative diagram showing a seal carrier 103 and selected components of a transmission 100. In this embodiment, the seal carrier 103 and the shaft 130 are bolted together. The seal carrier 103 may be coupled to the shaft casing 102 by a bearing (not depicted) in a known manner. The seal carrier 103 and shaft 130 illustrated include two hydraulic circuits including oil passages 104a and 104b that are connected to the rotating seal carrier 103 using seals 150 at each oil passage 104a and 104b. Oil passage 104a may be connected to a piston 146 that operates clutch 148 by oil under pressure delivered through radial passages 116 and 144, and axial passage 114. Oil passage 104b may be connected to a piston 140 that operates piston 142 via radial passages 124 and 138, and axial passage 120. The axial passages 114 and 120 are offset from an axial centerline 112 of the seal carrier 103 and shaft 130.

Pressurized oil from a source 136 may be coupled to oil passages 104a and 104b by control valves 132 and 134 respectively. When not connected to the source 136, the oil passages 104a and 104b may be connected to the drain rail 106. In an embodiment, the control valves 132 and 134 may dispense a low volume of oil into the oil passages 104a and 104b to maintain the fluid levels in the transmission even when not connected to the high pressure source 136. The control valves 132 and 134 may operate independently of each other. The process of pressurizing oil at the source 136 may cause air to be entrapped in the oil. As discussed above, air entrapped in the oil cause the transmission 100 to operate less effectively.

To aid in removing entrapped air in the oil, the seal carrier 103 may include a central passage 110 along the centerline 112 of the seal carrier 103. A radial passage 118 may connect the central passage 110 with an inner-facing surface of the axial passage 114. Similarly, a radial passage 126 may connect the central passage 110 with an inner-facing surface of the axial passage 120. When the seal carrier 103 and shaft 130 spin, oil is forced away from the centerline 112. The air, which is lighter than oil can separate from the oil via centrifugal action so that oil 152 and 156 collects away from the centerline 112 and air 154 and 158 collects nearer the centerline 112 in the axial passages 114 and 120, respectively. The central passage 110 may penetrate an entire length of the seal carrier 103 but a stopper 160 can be used to prevent leakage via the central passage 110.

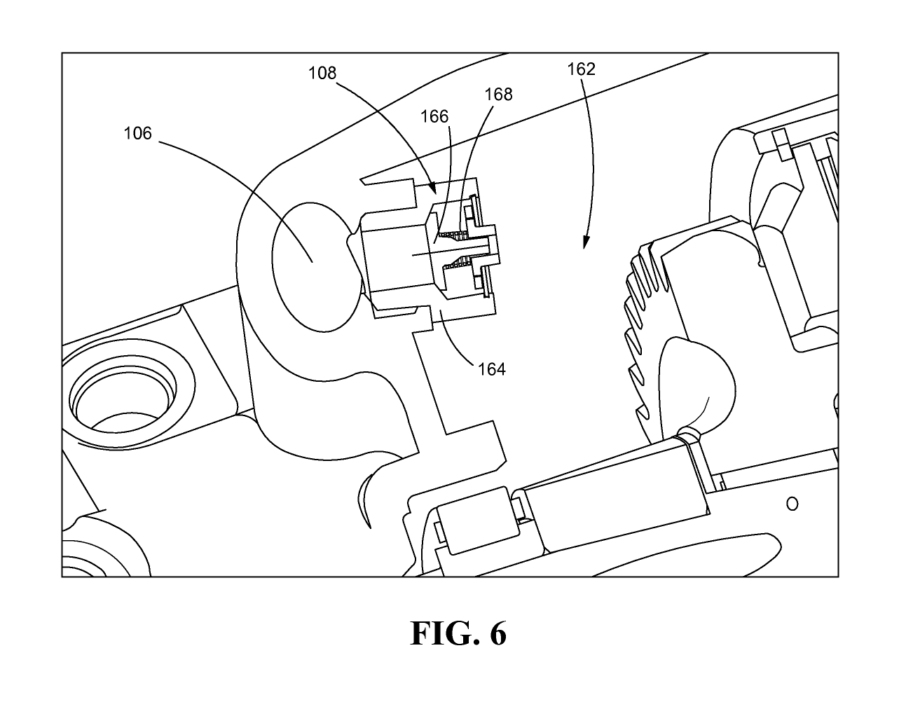

Air that is collected in the central passage 110 may be expelled to a tank 162 (see FIG. 6) via another radial passage 128. A pressure differential between the air 154, 158 released in the axial passages 114, 120 and the tank 162 may be created by the poppet valve 108 so that the released air is driven outward to the tank 162. The poppet valve 108 may be set for a low pressure such as 0.5 psi to 5 psi. In another embodiment, the poppet valve 108 may be designed to provide between 1.5 psi and 2.5 psi of back pressure. Even though oil may be ejected via the poppet valve 108 when the control valves 132 and 134 connect the oil passages 104a and 104b to the drain rail 106, the positive pressure is enough to force air out through the radial passage 128 into the tank 162.

In alternate embodiments, one or all of the radial passages 118, 126, and 128 may be cut as a groove in the shaft-end of the seal carrier 103 so that attaching the seal carrier 103 to the shaft 130 closes the groove and creates the respective passage.

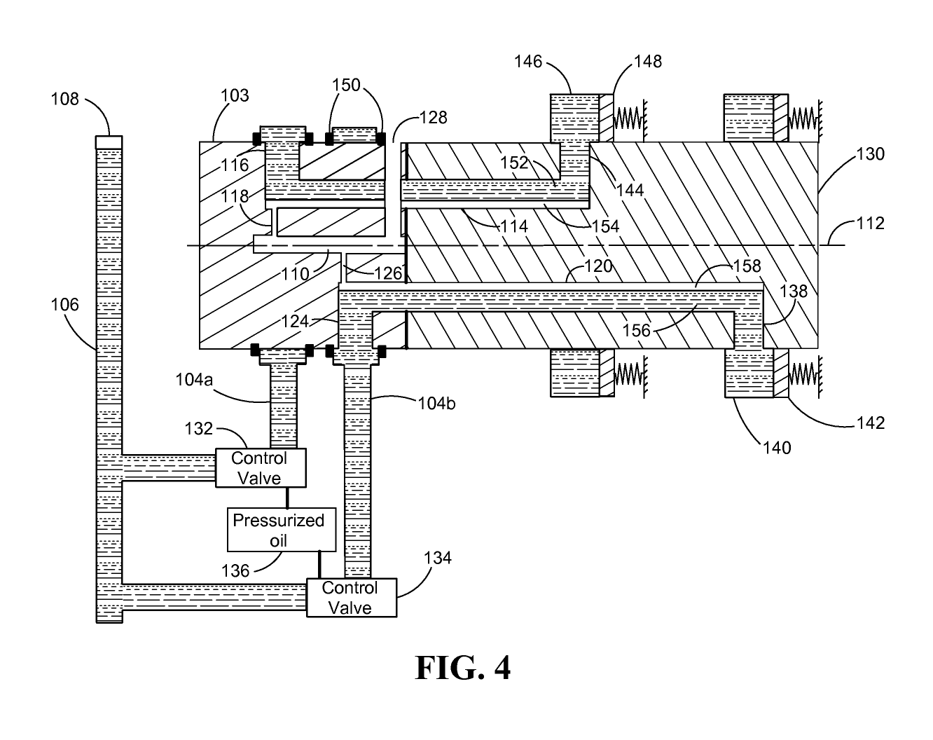

FIG. 4 is a variation of the embodiment illustrated in FIG. 3. In this embodiment, the central passage 110 does not penetrate the length of the seal carrier 103. In both the embodiments of FIG. 3 and FIG. 4, the central passage 110 may be manufactured, by drilling from a side nearer the shaft 130 although other manufacturing techniques may be utilized. The shaft 130 itself may act as a stop to block air flow in the direction of the shaft 130. Because of the low pressures involved, special seals at the shaft 130 may not be required.

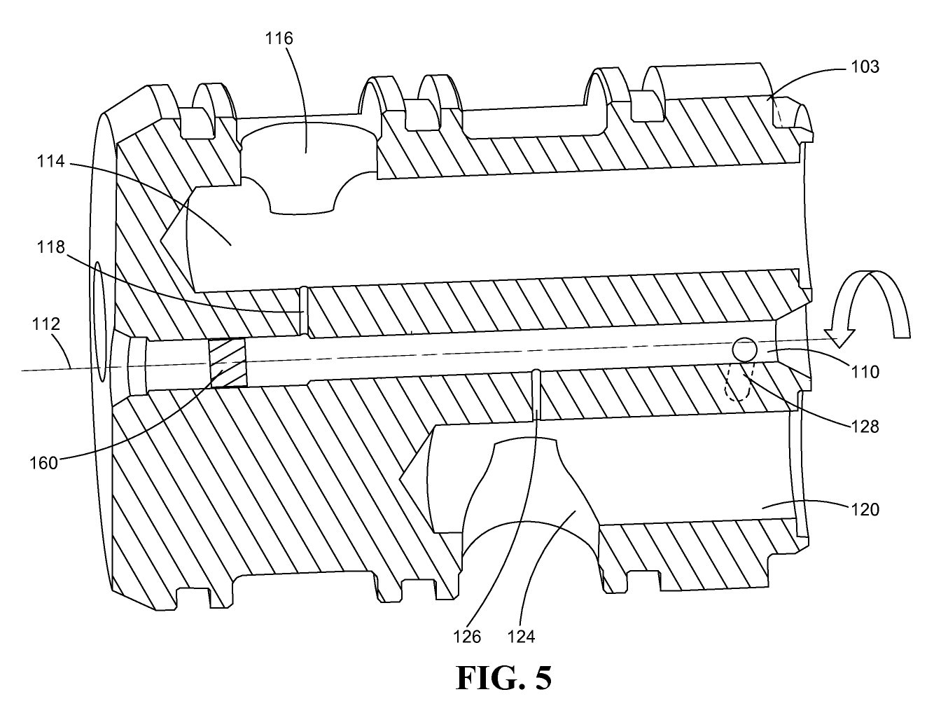

FIG. 5 is a cutaway view of a seal carrier 103. The seal carrier 103 may include axial passage 114 with radial passage 116. The seal carrier 103 may also include an axial passage 120 with radial passage 124. While the illustrated embodiment has two axial passages for oil, other embodiments may have more or fewer axial passages, depending on the requirements of the application. Passages 118 and 126 may connect the respective axial passages 114 and 120 with a central passage 110. Radial passage 128 may carry air that centrifuge action releases from the oil. The stopper 160 may prevent oil/air mixture from escaping via the central passage 110. As shown in the illustration of FIG. 5, radial passages 118 and 126 may be much smaller than the axial passages 114 and 120 in order to limit the loss of oil via the central passage 110, especially when under pressure during clutch activation. The radial passage 128 may be larger than the passages 118 and 126 to provide an exit path for both air and any oil that passes into the central passage 110.

FIG. 6 is a cutaway view of a poppet valve 108 in a drain rail 106. The poppet valve 108 connects the drain rail 106 to a tank 162. The poppet valve 108 may include a housing 164, a piston 166, and a spring 168. The spring 168 may be selected to provide the desired pressure in the drain rail 106 before opening to allow oil to enter the tank 162, such as 2 psi, in one embodiment.

The poppet valve 108 creates a slight positive pressure between the oil and the tank, which in turn forces the air from the central passage 110 out to the tank 162. Under some conditions, such as very low rotation speeds or very high pressures in the axial passages 114 or 120, there may be some oil flow through the radial passages 118 or 126 to the central passage 110, which is then discharged via the radial passage 128 to the tank 162. Because the radial passages 118 and 126 have a relatively small diameter this flow is minimized.

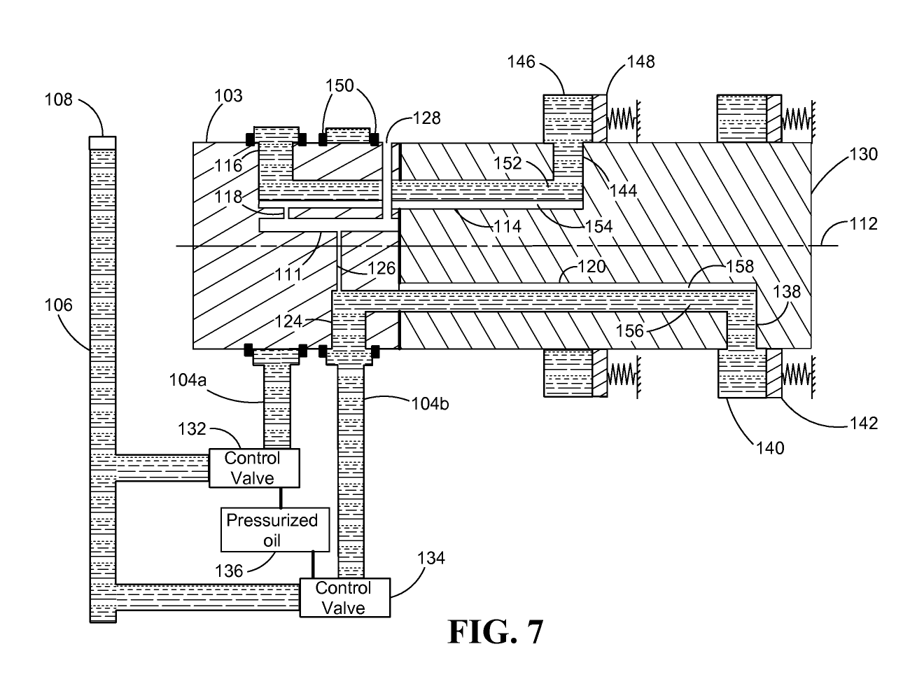

FIG. 7 is a simplified and representative diagram showing another embodiment of a deaerator apparatus. In this embodiment, a central passage 111 is not aligned with the axial centerline 112 but is closer to the centerline than the oil-carrying axial passages 114 and 120. In this embodiment, the air is still moved inward from the axial passages and then vented out through radial passage 128.

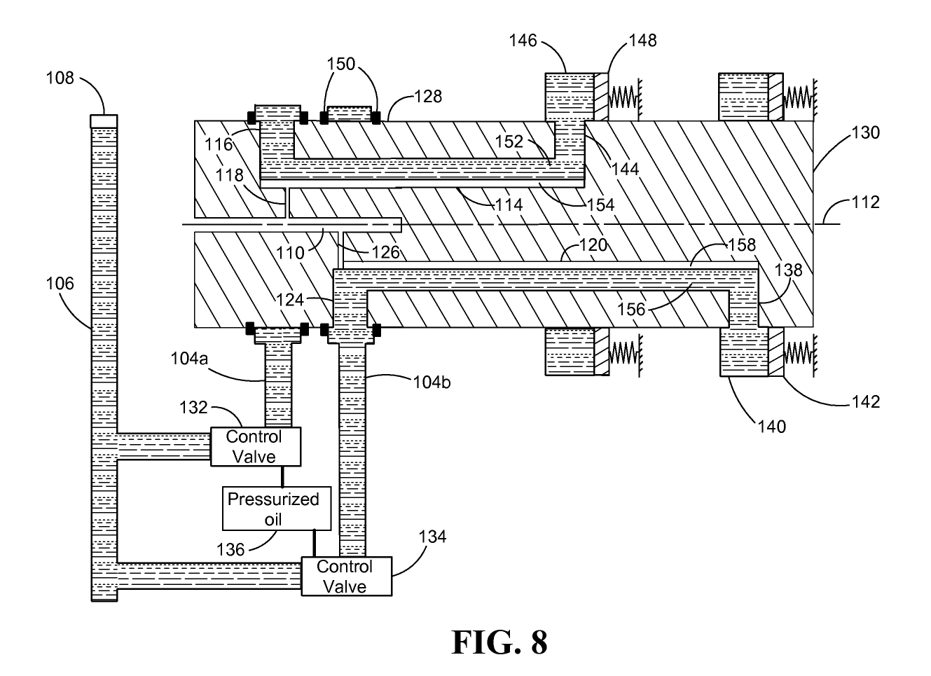

FIG. 8 is a simplified and representative diagram showing another embodiment of a deaerator apparatus. In this embodiment, there is no radial passage 128, rather, air, and any entrained oil may be vented via an opening in the central passage 110. In this embodiment, more oil may be discharged with the air that other embodiments with a secondary passage, such as passage 128. Also illustrated in this embodiment is a shaft 131 with the seal carrier functions built in so that a separate seal carrier is not incorporated in the shaft 130 of the other illustrated embodiments. In many cases the oil deaeration functions can be incorporated in a shaft design that does not use a separate seal carrier.

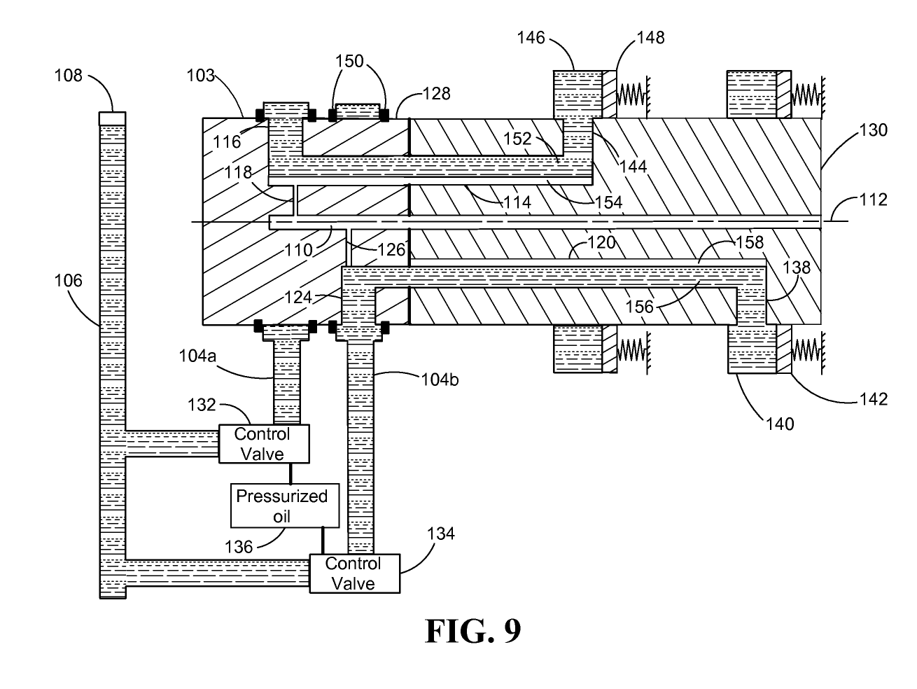

FIG. 9 is a simplified and representative diagram showing another embodiment of a deaerator apparatus. This embodiment is similar to that of FIG. 8 other than the central passage 110 is extended to the end of the piston 142 end of shaft 130 rather than the opposite end depicted in FIG. 8.

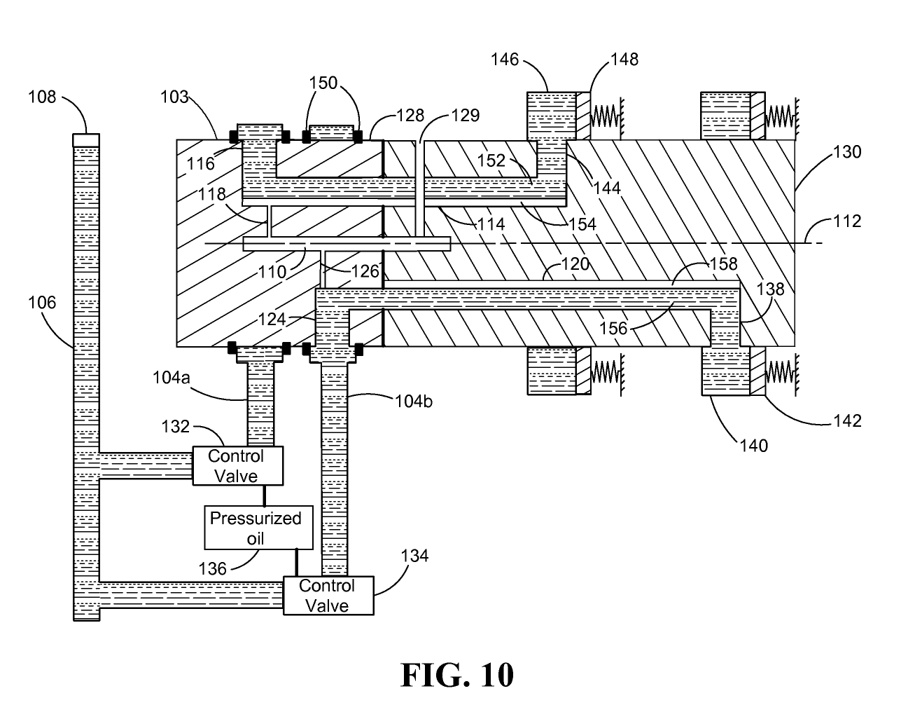

FIG. 10 is a simplified and representative diagram showing another embodiment of the deaerator apparatus. In this exemplary embodiment, the central passage 110 is extended into the shaft 130 and a radial shaft 129 is disposed in the shaft 130 rather that in the seal carrier 103 as shown in previous embodiments. As illustrated here, the other radial passages, e.g., passage 118 and/or 126 may also be disposed in the shaft 130.

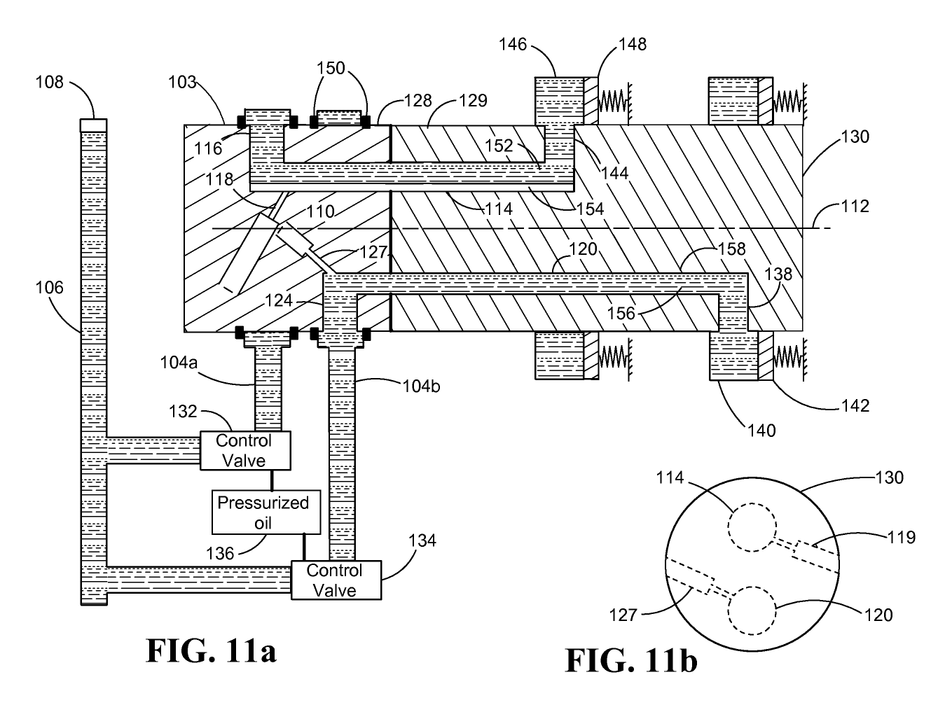

FIG. 11a and FIG. 11b is a simplified and representative diagram showing another embodiment of the deaerator apparatus. FIG. 11a illustrates that the air discharge passage need not be radial, but may be on an angle, but still exit through the outer surface of the seal carrier 103 as shown by passages 119 and 127. In another embodiment, the passages may exit via the front of the seal carrier 103.

The passages 119 and 127 may be larger in diameter at the outer surface and a smaller diameter at the axial passages 114 and 120. This small diameter portion reduces the oil loss via the passages 119 and 127 and also accommodates manufacturing by reducing the length of the small bore portion of the passages 119, 127.

FIG. 11b illustrates that the passages 119 and 127 extend to the outer surface of the seal carrier in this embodiment, although, as discussed above, the passages 119 and 127 may extend at a lower angle through the front surface as well.

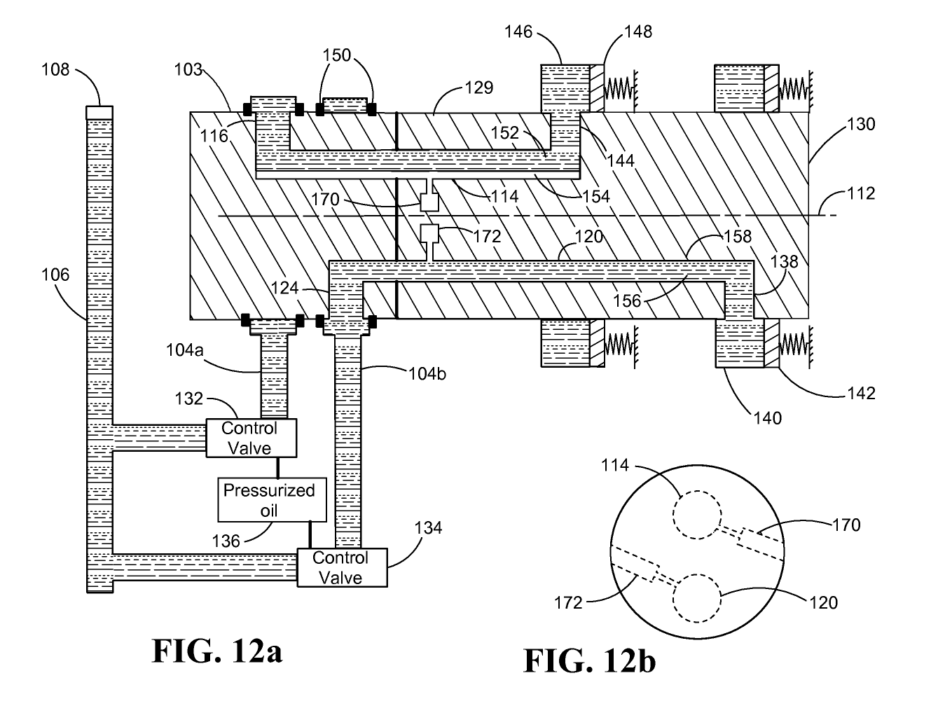

FIG. 12a and FIG. 12b is a simplified and representative diagram showing another embodiment of the deaerator apparatus. In this embodiment, radial passages 170 and 172 may be bored directly into the oil passages 114 and 120, respectively, in the shaft 130 rather than the seal carrier 103. FIG. 12b illustrates an end view of the passage 114 and its air shaft 170 and passage 120 and its air shaft 172.

### INDUSTRIAL APPLICABILITY

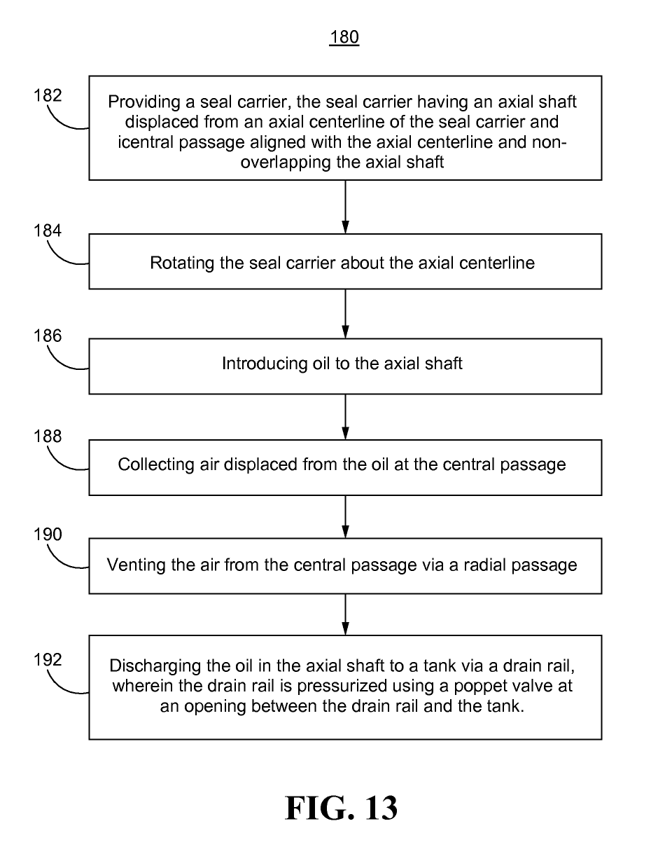

FIG. 13 is a flowchart of a method 180 of using a seal carrier 103 for deaerating oil or other hydraulic fluid. At a block 182, a seal carrier 103 may be provided. The seal carrier 103 may include an axial passage 114 generally parallel to and displaced from an axial centerline 112 of the seal carrier 103. The seal carrier 103 may also include a central passage 110 aligned with the axial centerline 112. In an embodiment, the central passage 110 and axial passage 114 do not overlap.

At a block 184, the seal carrier may be rotated about its axial centerline 112. In an embodiment, the seal carrier may rotate at between 0 rpm and 5000 rpm. At a block 186, oil may be introduced to the axial passage 114. As the seal carrier 103 and the associated shaft 130 are rotated, centrifugal/centripetal forces will develop in the axial passage 114 and air embedded in the oil may begin to separate from the oil.

At a block 188, air displaced from the oil in the axial passage 114 during rotation may be collected at the central passage 110 of the seal carrier 103. At a block 190, the air in the central passage 110 may be vented via a radial passage 118 in the seal carrier 103. wherein venting the air may include venting to the air to a tank 162. In an embodiment, pressure in the axial passage 114 may be maintained by a poppet valve 108 disposed between a drain rail 106 and the tank 162. In an embodiment, the poppet valve 108 may be set to maintain a pressure in the axial passage 114 of between about 1 psi and 3 psi. While the description of FIG. 13 illustrates axial passage 114, the method applies to all passages in the various embodiments discussed above. The seal carrier 103 and method 180 may be used at each shaft 130/shaft casing 102 in the transmission 100.

The oil deaerator and method described above has been shown in one embodiment to improve oil volume consistency by 200%, which directly translates to improved shift quality. The existing rotation of the seal carrier 103 and shaft 130 are utilized to provide the deaerating function with virtually no loss of energy in the system and without additional parts other than the simple poppet valve 108, saving valuable engine compartment space. Because each shaft casing 102 and its associated seal carrier 103 in the system can be adapted to the functions described, the deaeration functions can be distributed throughout the transmission 100, allowing deaeration to occur even as different shift combinations are engaged.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A deaerator system comprising:
a seal carrier including:
a cylindrical outer surface;
a central passage located around an axial centerline of the seal carrier;
a radial passage having a proximal end at the central passage and a distal end at the cylindrical outer surface;
an axial passage carrying hydraulic fluid through the seal carrier, the axial passage displaced from the axial centerline of the seal carrier; and
a second radial passage connecting the axial passage to the central passage, wherein the second radial passage has a smaller diameter than the axial passage.

2. The deaerator system of claim 1, wherein the seal carrier discharges air collected in the central passage through the distal end of the radial passage.

3. The deaerator system of claim 2, further comprising:
a tank coupled to the axial passage wherein the seal carrier also discharges oil via the radial passage to the tank.

4. The deaerator system of claim 1, wherein the seal carrier is configured to rotate about the axial centerline.

5. The deaerator system of claim 4, further comprising:
a poppet valve that creates a positive pressure in the second radial passage.

6. The deaerator system of claim 5, wherein a pressure setting of the poppet valve is between 0.5 psi and 5 psi.

7. The deaerator system of claim 5, wherein a pressure setting of the poppet valve is between 1.5 psi and 2.5 psi.

8. The deaerator system of claim 1, wherein the central passage is non-overlapping with the axial passage.

9. A method of centrifuging air from an oil supply, the method comprising:
rotating a component having a first passage and a second passage;
introducing oil to the first passage, the first passage displaced from an axial centerline of the component;
collecting air displaced from the oil in the second passage of the component, the second passage coupled to the first passage, the second passage having a smaller cross section than the first passage; and
venting the air in the second passage to a tank.

10. The method of claim 9, wherein the second passage is on the axial centerline of the seal carrier.

11. The method of claim 9, wherein the second passage is on an axial centerline of the component.

12. The method of claim 11, wherein the component is one of a shaft and a seal carrier of a transmission.

13. The method of claim 12, further comprising pressurizing the first passage.

14. The method of claim 13, wherein pressurizing the first passage comprises disposing a poppet valve between the first passage and the tank.

15. The method of claim 14, further comprising selecting a release pressure of the poppet valve at between 1 psi and 3 psi.

16. An apparatus that deaerates oil in a transmission, the apparatus comprising:
a shaft including:
a first passage that couples fluid to a piston;
a second passage that couples the first passage to a vent; and
a backpressure device coupled to the first passage, the backpressure device creating a positive pressure between the first passage and the vent, wherein air displaced via rotation of the shaft is vented via the second passage.

17. The apparatus of claim 16, wherein the second passage is smaller in cross section than the first passage.

18. The apparatus of claim 16, further comprising a third passage that couples the second passage to the vent, the third passage larger in cross section than the second passage.

19. The apparatus of claim 16, wherein the backpressure device is a poppet valve.

20. The apparatus of claim 19, wherein the poppet valve has a release pressure of between 1 psi and 3 psi.
